(19) United States
(12) Patent Application Publication
(10) Pub. No.: US 2014/0099030 A1
(43) Pub. Date: Apr. 10, 2014

(54) APPARATUS AND METHOD FOR PROVIDING OBJECT IMAGE RECOGNITION

(71) Applicant: Electronics and Telecommunications Research Institute, Daejeon (KR)

(72) Inventors: Hye-Jin KIM, Daejeon (KR); Jae Yeon LEE, Daejeon (KR)

(73) Assignee: Electronics and Telecommunications Research Institute, Daejeon (KR)

(21) Appl. No.: 14/021,799

(22) Filed: Sep. 9, 2013

(30) Foreign Application Priority Data
Oct. 4, 2012 (KR) 10-2012-0110219

(51) Int. Cl. G06T 7/00

(52) U.S. Cl. CPC G06T 7/0042
USPC 382/199

(57) ABSTRACT

An apparatus for providing an object image recognition includes a boundary extraction unit to extract a boundary of an object image. A feature extraction module extracts a center point of the object image and at least one local feature point from the extracted boundary and calculates each distance between the extracted center point and the extracted local feature point.

### RELATED APPLICATIONS

This application claims the benefit of Korean Patent Application No. 10-2012-0110219, filed on Oct. 04, 2012, which is hereby incorporated by reference as if fully set forth herein.

### FIELD OF THE INVENTION

The present invention relates to an object image recognition technology, and more particularly, to an apparatus and method for providing an object image recognition, which is appropriate to recognize and trace an object, and to extract features needed to recognize a pose of the object.

### BACKGROUND OF THE INVENTION

A method to extract features for object recognition includes techniques of extracting local features of an object to be processed and comparing features of the object within a database with the local features of the object so as to correspond to an object database model.

The technique of extracting local features makes use of the local features of the object, and thus, it has an advantage of recognizing the object even in the state there are factors such as a pose, size and occlusion of the object.

However, the technique has shortcomings in that the object may be precisely recognized if a plurality of local features is extracted from the object, and a recognition ratio is lowered because a lot of comparison between the local features should be conducted.

Meanwhile, the techniques for extracting local features in the art include Harris detector, Harris Laplace detector, Hessian Laplace, Harris/Hessian Affine detector, Uniform detector, Shape Contexts, Image Moments, Gradient Location and Orientation Histogram, Geometric Blur SIFT (Scale-invariant feature transform), and SURF (Speeded Up Robust Features). Among them, the techniques of SIFT and SURF are highlighted as techniques to recognize an object. It is because the SIFT and SURF techniques can robustly recognize objects even when the objects are occluded by something else or have different positions or poses.

Besides techniques known as local features, feature values indicating any features of the object may be used to extract the local features. For example, KLT (Kanade-Lucas-Tomasi) feature technique may be used as a local feature value of an object.

However, while a recognition with a high reliability may be possible when features are further extracted from an object, redundant features or overlapped features may be further extracted. Further, with many features, there is a shortcoming that it takes an unusually long time to search for an object.

### SUMMARY OF THE INVENTION

In view of the above, the present invention provides an apparatus and method for providing an object image recognition, capable of being robust to a pose, size and occlusion of an object and reducing a matching time to recognize an object image.

In accordance with an aspect of an exemplary embodiment of the present invention, there is provided an apparatus for providing an object image recognition, which includes: a boundary extraction unit configured to extract a boundary of an object image; and a feature extraction module configured to extract a center point of the object image and at least one local feature point from the extracted boundary and calculate each distance between the extracted center point and the extracted local feature point.

The apparatus further includes a post-processing unit configured to enhance features characteristics such as less redundancy and directionality to each distance calculated through the feature extracting unit.

In the embodiment, the post-processing unit applies at least one of sorting, clustering, classifying and windowing techniques. Feature points can be sorted, clustered, classified in order to eliminate the redundancy of features as well as to enhance robustness to rotation and varying scales.

In the embodiment, the feature extraction module includes: a center point extraction unit configured to extract a center point of the object image from the boundary which is extracted from the boundary extraction unit; a local feature extraction unit configured to extract at least one local feature point from the boundary that is extracted from the boundary extraction unit; and a distance calculation unit configured to calculate a distance between the center point and the at least one local feature point.

In the embodiment, each of the distances has a value which is not dependent on a pose or position of the object image or has a value which is not dependent on occlusion of the local feature point of the object image.

In accordance with another aspect of the exemplary embodiment of the present invention, there is provided a method for providing object image recognition in an apparatus for providing object image recognition, which includes: extracting a boundary of an object image that is input from the outside; extracting a center point of the object image from the boundary extracted; extracting at least one local feature point of the object image from the boundary extracted; and calculating a distance between the center point and the at least one local feature point.

In the embodiment, the calculating a distance includes: post-processing the distance between the center point and the at least one local feature point.

In the embodiment, the post-processing the distance comprises at least one of: sorting the distance; clustering the distance; classifying the distance; and windowing the distance.

In the embodiment, the distance has a value which is not dependent on a pose or position of the object image or a value which is not dependent on occlusion of the local feature point of the object image.

In accordance with the present invention, it is possible to make the object image recognition with robustness to a pose, size and occlusion of an object, precision and rapidness, by calculating distances between the center point of the object and local features and then extracting features of the object.

### BRIEF DESCRIPTION OF THE DRAWINGS

The above and other objects and features of the present invention will become apparent from the following description of the embodiments given in conjunction with the accompanying drawings, in which:

FIG. 1 is a schematic block diagram of an apparatus for proving an object image recognition in accordance with an exemplary embodiment of the present invention;

FIG. 2 is a detailed block diagram of a feature extraction module shown in FIG. 1;

FIG. 3 is a conceptual diagram illustrating the functions of a post-processing unit shown in FIG. 1;

FIG. 4 is a perspective diagram illustrating a case that a sorting technique among post-processing techniques of X-D (feature information resulted from the calculation of distances between a center point and local features of an object image);

FIG. 5 is a graph illustrating a result of sorting distances from a center point of an object image of FIG. 4;

FIG. 6 is a perspective diagram illustrating a case that features within a radius r are sorted, which express a meaning of sorted values in FIG. 5; and

FIG. 7 is a perspective diagram illustrating a feature patch for local features of an object image, into which a technique of clustering or sorting among post-processing techniques in FIG. 4 is incorporated.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

The combinations of the each block of the block diagram and each operation of the flow chart may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer usable memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment, thereby a process executed by a computer being generated.

Moreover, the respective blocks or the respective sequences may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

Before discussing an exemplary embodiment of the present invention, it is noted that the present invention has a technical idea that calculates distances between a center point of an object and local features and extracts features of the object to thereby achieve robustness to a pose, size and occlusion of an object and reduce a matching time for cognizing an object image, whereby the subject of the present invention will be achieved easily from the above technical idea.

Hereinafter, embodiments of the present invention will be described in detail with reference to the accompanying drawings which form a part hereof.

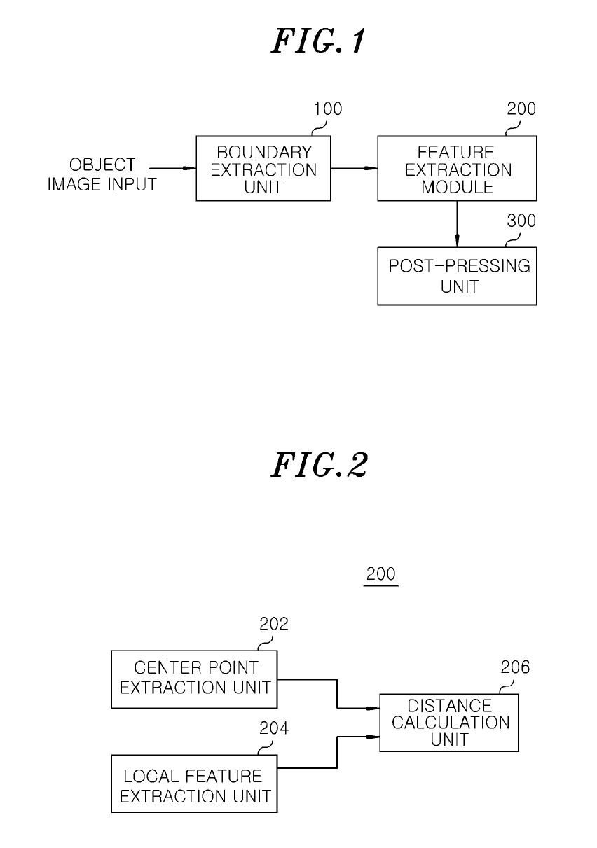

FIG. 1 is a schematic block diagram of an apparatus for proving an object image recognition in accordance with an exemplary embodiment of the present invention, which includes a boundary extraction unit 100, a feature extraction module 200, and a post-processing unit 300.

Referring to FIG. 1, the boundary extraction unit 100 serves to extract boundary information from an object image which is provided thereto from the outside.

The feature extraction module 200 extracts a center point C and local features (referred to as a feature X, hereinafter) in an object image from boundary information of the object image that is extracted through the boundary extraction unit 100, and calculate a distance D between the center point C and feature X of the object image. In this case, the feature X may be defined to be plural features in number depending on a shape of the object.

While FIG. 1 demonstrates components that extract boundary information and then feature information of the object image, it will be easily understood to those skilled in the art that such demonstration is merely an example and does not limit the components in order arranged.

The feature extraction module 200 includes a center point extraction unit 202, a local feature extraction unit 204 and a distance calculation unit 206 as illustrated in FIG. 2.

Referring to FIG. 2, the center point extraction unit 202 extracts a center point C of an object image from the boundary information of the object image that is extracted through the boundary extracting unit 100, and the local feature extraction unit 204 extracts a plurality of features X of the object image from the boundary information of the object image. It is also noted that the sequence of extracting the center point C and then the feature X is not limited in that order.

In accordance with an embodiment of the present invention, the local feature extraction may be obtained by KLT (Kanade-Lucas-Tomasi) feature technique.

The distance calculation unit 206 calculates each distance D between the center point C and features X of the object image.

The distance D extracted by the distance calculation unit 206 may be expressed as a following Equation 1. The equation 1 illustrates a case of obtaining a distance D(k) between feature X^{k}(x,y) corresponding to O(k) which is a k-th patch and C(k) which is a center point of the k-th patch.

$$D ( k ) = {\sum }_{x , y ∈ 0 ( k )}^{ } {\vert {X}^{k} ( x , y ) - C ( k ) \vert}^{2} , \\ where \\ k = 1 , … , n \qquad Eq . 1$$

As such, the distance between the center point C and feature X of the object image is referred to as “feature X-D”. The feature X-D can be obtained using Euclidean distance measuring technique, for example. However, such distance measuring technique is merely an example, and it will be appreciated by those skilled in the art that a variety of different distance measuring techniques such as p-norm, Mahalanobis distance, RBF distance, and others may also be applied.

Meanwhile, in accordance with an embodiment of the present invention, D(k)′ is obtained by additionally calculating the D(k) so as to be robust to the change in size of the object within the object. For example, as illustrated in a following Equation 2, it may be embodied that a distance value is not affected by the change in size of the object, by dividing the distance D(k) by the boundary information of the object to be processed, that is, the maximum value of an arbitrary feature patch.

$${D ( k )}^{′} = \frac{D ( k )}{{max}_{{X}^{k} ∈ 0 ( k )} ( {\vert {X}^{k} ( x , y ) - C ( k ) \vert}^{2} )} , \\ where \\ k = 1 … , n \qquad Eq . 2$$

Referring to FIG. 1 again, the post-processing unit 300 performs a post-processing on the feature X-D that is finally extracted through the feature extraction module 200, which gives an additional distinguishing meaning. That is, while the feature X-D may fully express features of the object in itself, the embodiment of the present invention may realize the redundancy, directionality or patch by adding the post-processing unit 300, thereby obtaining more accurate information.

As illustrated in FIG. 3, the post-processing unit 300 utilizes any one of the sorting, clustering, classifying and windowing techniques to give meaning to the features. For example, when it is assumed that the distance extracted through the feature extraction module 200 is a feature X-D′, the feature X-D′ is structuralized through the sorting, clustering, classifying and windowing of the post-processing unit 300 and changed to represent features of the object to be processed, whereby it is possible to finally obtain a feature X-D.

In this regard, the sorting is a technique that is applicable to the feature having arbitrary continuous values, and the clustering is a technique used to classify the patches with various determining references without learning. Further, the classifying is a technique in which an image patch to be processed is determined in advance and subjected to learning for a local area so as to look for boundary and relative center point of the local area. The windowing is a technique in which a window is defined, and several patches are generated while shifting the window, in case of a complicated image in which it is not easy to obtain the patch or boundary for each object.

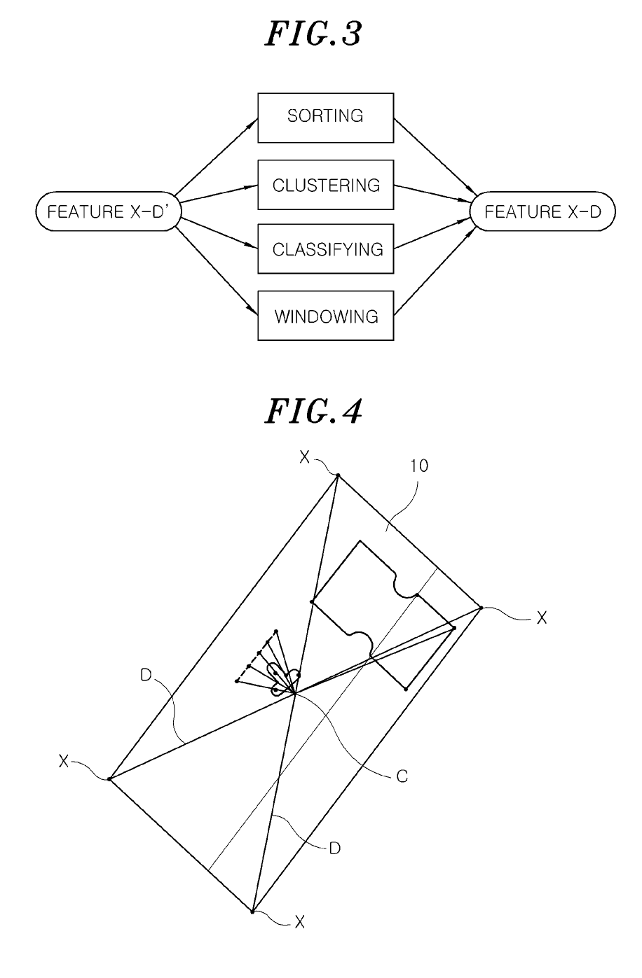

FIGS. 4 to 6 are views illustrating a case of sorting the feature X-D.

First, FIG. 4 illustrates an arbitrary object image 10, wherein a symbol X indicates each feature, and a symbol D indicates a distance between a center point C and each feature X.

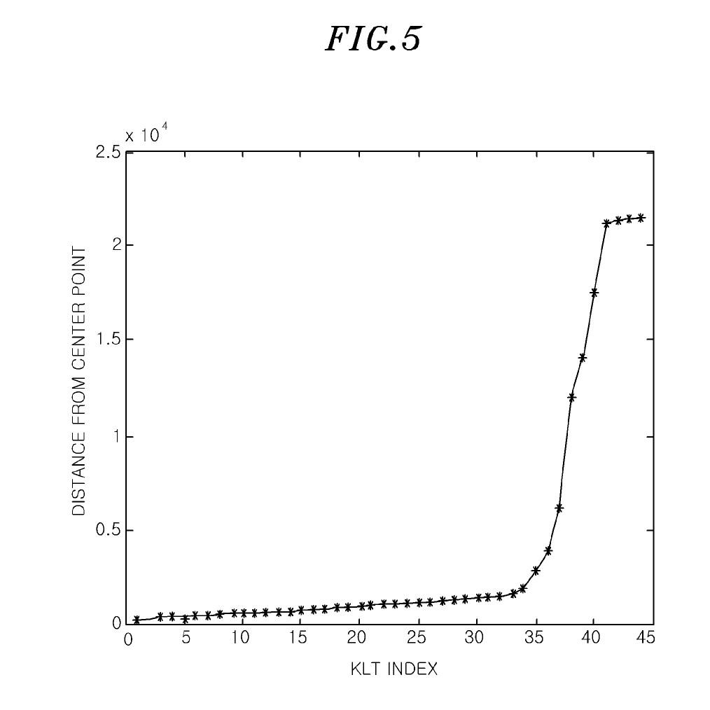

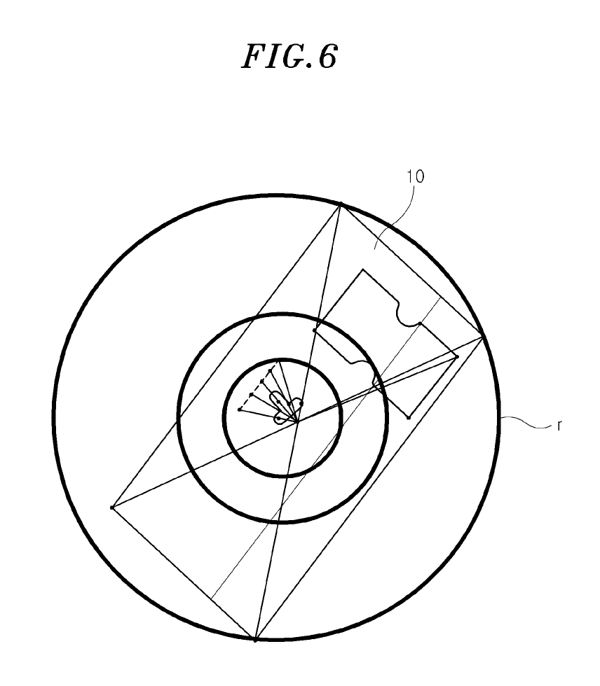

FIG. 5 is a graph illustrating a result of sorting the distance from the center point C of the object image 10 in FIG. 4, to which the KLT (Kanade-Lucas-Tomasi) feature technique may be used, for example.

FIG. 6 expresses a meaning of a sorted value in FIG. 5, which is a perspective diagram illustrating a case that features within a radius r are sorted. In FIG. 6, the sorted feature values continuously indicate a group of features within each circle having a distance value of a radius r, in which it can be expressed by sorting in case that the radius r has a continuous value. Especially, FIG. 6 may be used to select a feature for rapid identification with respect to the object whose feature is small in number.

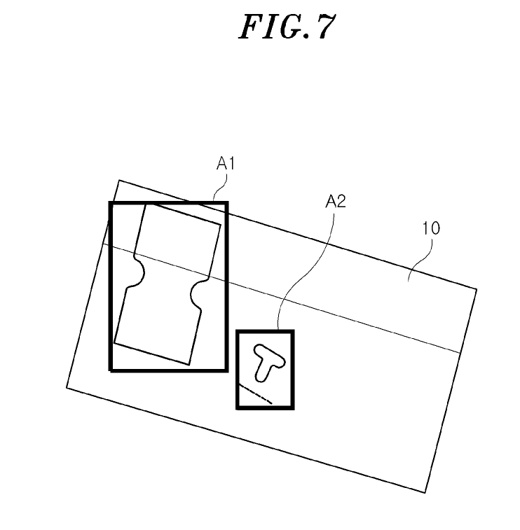

FIG. 7 shows a case where a clustering or classifying technique among post-processing techniques in FIG. 4 is applied, which is a perspective diagram illustrating a feature patch for a local feature of an object image.

The clustering technique and classifying technique may be usefully utilized in making a feature patch, and a feature X-D may be extracted by clustering or classifying adjacent feature patches A1 and A2 as illustrated in FIG. 7.

The approaching method to obtain the boundary of each patch in FIG. 7 may employ sorting, clustering, classifying or windowing technique depending on an image to be processed.

The method of grouping the feature X-D illustrated in FIG. 7 has an advantage that allows the features to associate with each other more stereoscopically and closely by adding geometric or additional information with respect to the object.

As described above, the feature X-D in the distance value information on a distance from the center point of the object, and thus, it does not matter where the object is in the image (which results in ensuring consistency for pose and position of the object).

Further, even though the local feature is occluded or disappeared, it is possible to recognize the object through information obtained from other feature values (which results in ensuring consistency for occlusion of the object).

In accordance with the present invention, a technique for an object image recognition is implemented by calculating distances between the center point of the object and local features and then extracting features of the object, thereby making the object image recognition with robustness to pose, size and occlusion of an object, precision and rapidness.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for providing an object image recognition, the apparatus comprising:
a boundary extraction unit configured to extract a boundary of an object image; and
a feature extraction module configured to extract a center point of the object image and at least one local feature point from the extracted boundary and calculate each distance between the extracted center point and the extracted local feature point.

2. The apparatus of claim 1, further comprising:
a post-processing unit configured to add redundancy and directionality to each distance calculated through the feature extracting unit.

3. The apparatus of claim 2, wherein the post-processing unit applies at least one of sorting, clustering, classifying and windowing techniques.

4. The apparatus of claim 1, wherein the feature extraction module comprises:
a center point extraction unit configured to extract a center point of the object image from the boundary which is extracted from the boundary extraction unit;
a local feature extraction unit configured to extract at least one local feature point from the boundary that is extracted from the boundary extraction unit; and
a distance calculation unit configured to calculate a distance between the center point and the at least one local feature point.

5. The apparatus of claim 4, wherein the each distance has a value which is not dependent on a pose or position of the object image.

6. The apparatus of claim 4, wherein the each distance has a value which is not dependent on occlusion of the local feature point of the object image.

7. A method for providing object image recognition in an apparatus for providing object image recognition, the method comprising:
extracting a boundary of an object image that is input from the outside;
extracting a center point of the object image from the boundary extracted;
extracting at least one local feature point of the object image from the boundary extracted; and
calculating a distance between the center point and the at least one local feature point.

8. The method of claim 7, wherein said calculating a distance comprises:
post-processing the distance between the center point and the at least one local feature point.

9. The method of claim 8, wherein said post-processing the distance comprises at least one of:
sorting the distance;
clustering the distance;
classifying the distance; and
windowing the distance.

10. The method of claim 9, wherein the distance has a value which is not dependent on a pose or position of the object image.

11. The method of claim 9, wherein the distance has a value which is not dependent on occlusion of the local feature point of the object image.
